(19) United States
(12) Patent Application Publication
(10) Pub. No.: US 2010/0105230 A1
(43) Pub. Date: Apr. 29, 2010

(54) CONNECTOR

(75) Inventor: Lars DAVIDSSON, HELSINGBORG (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/256,517

(22) Filed: Oct. 23, 2008

(51) Int. Cl. H01R 13/62; H01R 4/00

(52) U.S. Cl. 439/260; 439/874

(57) ABSTRACT

The present invention relates to a method and to a radio communication terminal comprising a flex film and a electrical connector, wherein the flex film comprises at least one connector portion, the connector portion is adapted to be electronically connected to the electrical connector, the electrical connector comprises a guide, the connector portion of the flex film comprises a guide follower, and the guide and the guide follower are adapted to interact to connect the flex film to the electrical connector.

### TECHNICAL FIELD

The present invention relates to a method and a radio communication terminal comprising a flex film and an electrical connector for a printed circuit board.

### BACKGROUND ART

The first commercially attractive cellular phones or terminals were introduced on the market at the end of the 1980's. Since then, a lot of effort has been made in making smaller radio communication terminals, with much help from the miniaturisation of electronic components and the development of more efficient batteries. Today, numerous manufacturers offer pocket-sized radio communication terminals with a wide variety of capabilities and services.

In order to attract customers the terminal manufacturers have therefore taken further measures to strengthen their position in the competition. Size and cost is getting more and more essential in mobile handsets design. The marked trend is that mobile handsets are getting both thinner and smaller.

Many electronic devices such as mobile telephones, computers, media players and so forth include printed circuit boards (PCB). Printed circuit boards also may be referred to as printed wire boards. The printed circuit board may retain one or more circuit components (e.g., integrated circuit packages) and may establish connectivity to contacts of the circuit components. For instance, the printed circuit board may include conductive electrical signal pathways to connect the circuit component to power, ground and/or other signals. In addition, the printed circuit board may include conductive electrical pathways to connect the circuit component to another component that is mounted on the printed circuit board (e.g., another integrated circuit package) or another component that is located remotely off of the printed circuit board so that signals may be exchanged between the circuit component and these other components.

Flex films are generally used to connect printed circuit boards to other printed circuit boards. Conventional flex films are often hand mounted and there is a problem of incorrect mounting. Another problem is that the flex film is disconnected due to some force exerted on the radio communication terminal. This is a problem since the customer expects that the radio communication terminals should have a high degree of durability, i.e. that the radio communication terminals should function. Another problem is that the assembly of the flex film and the printed circuit board is time consuming.

### SUMMARY OF THE INVENTION

A radio communication terminal defined in claim 1 and a method for connecting a connector portion of a flex film comprising a guide follower to an electrical connector comprising a guide defined in claim 14 are provided according to the present invention.

More specifically one aspect of the invention relates to a radio communication terminal comprising a flex film and a electrical connector, wherein the flex film comprises at least one connector portion, the connector portion is adapted to be electronically connected to the electrical connector, the electrical connector comprises a guide, the connector portion of the flex film comprises a guide follower, and the guide and the guide follower are adapted to interact to connect the flex film to the electrical connector.

An advantage of such a radio communication terminal is that it makes the mounting of the flex film to the electrical connector easier.

Another advantage is that guide and the guide follower create a feedback that the flex film is mounted correctly.

A further advantage is that the interaction of the guide and the guide follower enables a stronger connection of the flex film to the electrical connector.

The guide and the guide follower may be adapted to interact to absorb forces exerted on the flex film and the electrical connector to even further enhance the strength and durability of the connection of the flex film and the electrical connector. A further advantage of this is that the size of electrical connector could be reduced since the guide and guide follower absorbs forces in a good way. Another advantage is that the guide and the guide follower reduces the risk of that the connector portion of the flex film unintentionally is dismounted from the electric connector.

To even further reduce the time to connect the flex film to the electrical connector the guide and the guide follower may be adapted to interact to only enable a correct connection of the flex film to the electrical connector. A further advantage of this is that the risk of that the flex film and electrical contact is broken during assembly is reduced.

An easy, durable and economical way to make the guide is that the guide may comprise a pin.

An easy, durable and economical way to make the guide follower is that the guide follower may comprise a through hole in the connector portion of the flex film that is adapted to be mounted on the pin.

To even further enhance the absorption of forces, the guide may comprise two pins. A further advantage of this is that it further reduces the time of connecting the flex film to the electrical connector. A further advantage is that the risk of that the flex film is mounted incorrect to the electrical connector is further reduced.

Thee guide follower may comprise two through holes.

A cost and time effective and secure way to reduce the risk of incorrect mounting of the flex film to the electrical connector is that the guide may be positioned unsymmetrical in relation to the width of the electrical connector. This also creates feedback during mounting since the flex film only may be oriented in one way to interact with the guide.

The cross sectional shape of the guide may be unsymmetrical. The cross sectional shape of the pin may be unsymmetrical. The shape of the guide follower may correspond to the shape of the guide. An advantage of this is that feedback may be created during mounting and that the risk if incorrect mounting is be reduced.

The cross sectional shape of the pin may correspond to the shape of the through hole.

The radio communication terminal may further comprise a printed circuit board and the electrical connector may be mounted on said printed circuit board.

According to another aspect of the invention, the invention relates to a method for connecting a connector portion of a flex film comprising a guide follower to a electrical connector comprising a guide, comprising the steps of arranging the guide follower at the guide, moving the connection portion into a connected position in the electronic connector, whereby the movement is guided by the interaction of the guide follower and the guide.

An advantage of this method is that feedback is created to reduce the risk of incorrect mounting. Another advantage is that the risk of that some part is damaged during assembly is reduced. Another advantage is that the flex film is stronger and better connected to the electronic connector. A further advantage is that the guide and guide follower may absorb forces.

The guide may be a pin and the guide follower may be a through hole, the pin may be inserted into the hole and the pin and the hole interacts to guide the movement of the connector portion in relation to the electrical connector. This is a time and cost effective and strong way of connecting the flex film to the electronic connector.

The pin and the through hole may have a corresponding and unsymmetrical shape and that said pin only is arrangeable in said hole in one orientation. By this the advantages of further reducing the time needed to connect the flex film to the electric connector and reducing the risk of incorrect connection is achieved.

### BRIEF DESCRIPTION OF THE DRAWINGS

The features and advantages of the present invention will be more apparent from the following description of embodiments with reference to the accompanying drawings, in which

FIG. 1 schematically illustrates a radio communication terminal.

FIG. 2 schematically illustrates a printed circuit board on which an electrical connector and a flex film are mounted.

FIG. 3 schematically illustrates an electrical connector comprising a guide.

FIG. 4 schematically illustrates a flex film comprising a guide follower.

FIG. 5 schematically illustrates a flex film that is connected to an electrical connector.

### DETAILED DESCRIPTION

In the following description reference is made to the accompanying drawings. In this regard directional terminology, such as “top”, “bottom”, “front”, “back” etc, is used with reference to the orientation of the figures being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present protection. The following detailed description is not to be taken in a limiting sense, and the scope of the present invention is defined by the appended claims.

The present description relates to the field of radio communication terminals. The term radio communication terminal or communication terminal includes all mobile equipment devised for radio communication with a radio station, which radio station also may be mobile terminal or e.g. a stationary base station. Consequently, the term radio terminal includes mobile telephones, pagers, communicators, electronic organisers, smart phones, PDA:s (Personal Digital Assistants) and DECT terminals (Digital Enhanced Cordless Telephony).

Embodiments of the present invention relate, in general, to a radio communication terminal, such as a mobile phone. However, for the sake of clarity and simplicity, most embodiments outlined in this specification are related to mobile phones.

Furthermore, it should be emphasised that the term comprising or comprises, when used in this description and in the appended claims to indicate included features, elements or steps, is in no way to be interpreted as excluding the presence of other features elements or steps than those expressly stated.

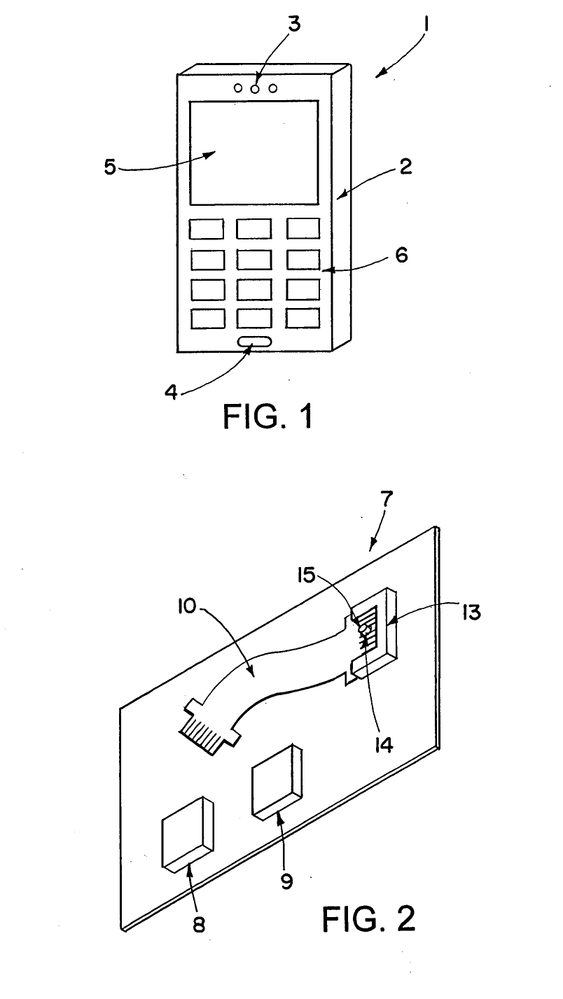

Exemplary embodiments will now be described with references made to the accompanying drawings. FIG. 1 discloses an radio communication terminal 1 comprising a casing 2, a speaker 3, a microphone 4, a display 5 and a key pad 6.

One or more of the components described above may be secured directly to a printed circuit board 7, inside the casing 2, that comprises a processing device 8 and a control circuitry 9 and/or be located remotely on a second printed circuit board (not shown) or by itself and/or with other functional components. One or more printed circuit boards (not shown) are connected to the printed circuit board 7 using an electrical flex film 10.

Flex films as such are known in prior art and will thus not be further described herein. Flex films are sometimes also known as flex foils or flex connectors, the wording flex film herein should be understood to be a flexible film that is adapted to be electronically connected to a connector.

An electrical connector 13 is mounted on the printed circuit board 7. The flex film 10 is connected to the printed circuit board 7 by connecting the flex film to the electrical connector 13. The flex film 10 may be locked to the electrical connector 13 by a lock (not disclosed).

Referring to FIG. 4, an electrical flex film 10 in accordance with an aspect of the present invention is illustrated. The electrical flex film 10 may be made from a conductive material or a non-conductive material depending on the design and the needs of the application. As shown in FIG. 4, the electrical flex film 10 is formed from a body 11. The body 11 is generally a unitary construction manufactured from a resilient or flexible material. For example, the electrical flex film 10 may be manufactured from spring steel, titanium, steel, or any other resilient or flexible conductive and/or non-conductive material.

The electrical flex film 10 may be manufactured in any desired manner. One way of manufacturing the electrical flex film 10 is by die cutting a desired material (e.g., spring steel) and applying compressive force on the body 11 to achieve the desired structure. One of ordinary skill in the art will readily appreciate that there are a variety of ways to form the electrical flex film 10.

The body 11 includes a connection portion 12 for connecting the flex film 10 to the electrical connector 13. The connector portion 12 comprises a guide follower 14. The guide follower 14 is in the shown embodiment a through hole 14. The through hole has in the shown embodiment a round shape. However, the shape of the through hole could have many other shapes, such as triangular, rectangular or an unsymmetrical shape.

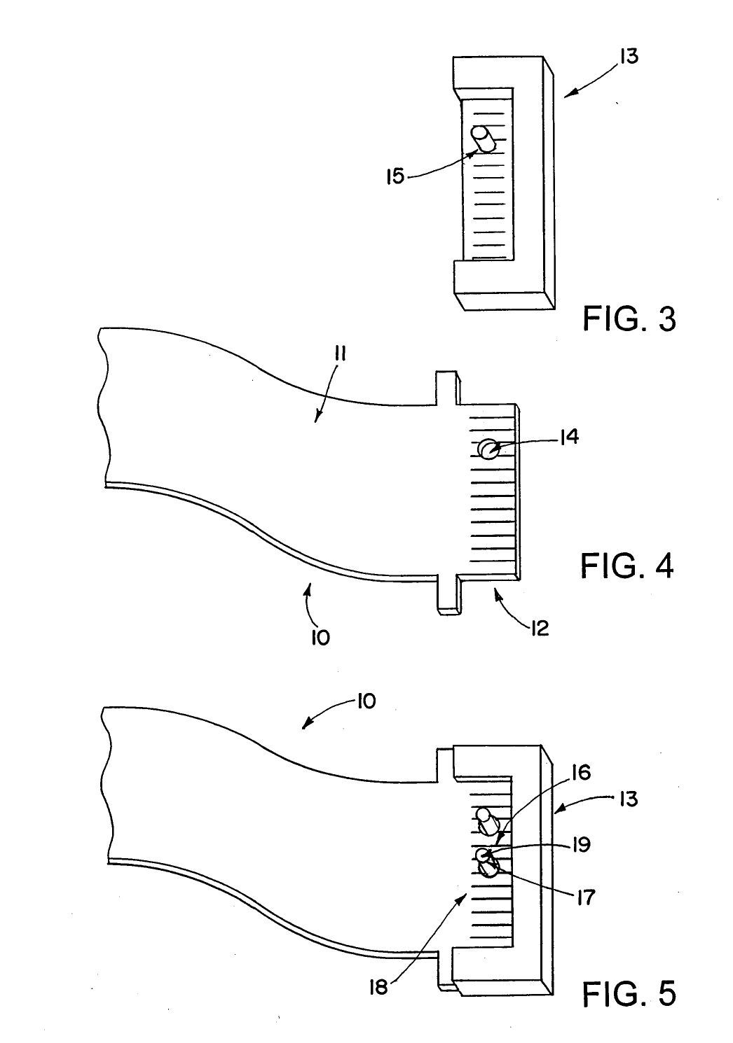

As shown in FIG. 3, the electrical connector 12 comprises a guide 15 and has a U-shape. The electrical connector 13 is adapted to receive the connector portion 12 through the open end. The guide 15 may comprise a pin 16. The electrical connector 13 may be soldered or otherwise secured to the printed circuit board 7 by an adhesive, tape or glue. The cross sectional shape of the pin 16 is circular in the shown embodiment. However, the cross sectional shape of the pin could be of many other shapes, such as triangular, rectangular or an unsymmetrical shape.

With reference to FIG. 2, to connect the flex film 10 to the electrical connector 13, the guide follower 14 of the connector portion 12 of the flex film 10 is arranged at the guide 15 of the electrical connector 13. The guide follower 14 is thereafter moved onto the guide 15. In the shown embodiment the pin 15 is inserted into the through hole 14 of the flex film 10. Thereafter the flex film 10 is moved towards the electrical connector 13. The pin 15 and the through hole 14 interact and guide the flex film 10 into a correct position in the electrical connector 13. After the flex film 10 has been connected to the electrical connector, the pin 15 and the through hole 14 will interact to absorb forces that are exerted on the flex film 10 and/or the electrical connector 13. In the shown embodiment the pin 15 and the through hole 14 are adapted to at least absorb forces that is perpendicular to said movement of the flex film 10 in relation to the electrical connector 13. Such a force could for instance be due to that the radio communication terminal 1 is dropped or that a person or a machine that assembles the radio communication terminal 1 touches the flex film 10.

If the guide 15 and the guide follower 14 is unsymmetrical arranged over the width of the flex film 10 and the electronic connector 13, the guide 15 could only interact with the guide follower 14 in a intended manner if the flex film 10 is arranged in relation to the electronic connector 13 in a predetermined manner. The width of the flex film 10 and the electronic connector 13 is the direction that is perpendicular to the direction in which the flex film 10 is moved in relation to the electronic connector 13 to connect the flex film 10 to the electronic connector 13. This makes it easier for a person that assembly the radio communication terminal 1 since it gives feedback if the flex film 10 is correct oriented in relation to the electronic connector 13 or not.

Reference is now made to FIG. 5 that discloses a flex film 10 comprising a guide follower 16 and an electronic connector 13 comprising a guide 17.

The guide follower 16 comprises two through holes 16 in a connector portion 18 of the flex film 10. The two holes 16 are unsymmetrical located over the width of the connector portion 18.

The guide 17 comprises two pins 19. The two pins 19 are unsymmetrical located in locations that correspond to the location of the two holes 16.

To connect the flex film 10 to the electronic connector 13 the pins 19 are arranged in the holes 17. The location of the holes only allows the flex film 10 to be arranged in a predetermined manner in relation to the electronic connector 13. The location of the guide 17 and the guide follower 16 reduces the risk of that the flex film 10 is incorrect connected. It also reduces the risk of that a device is damaged due to incorrect connection. Further, it also reduces the time for assembly since the person connecting the flex film to the electronic connector 13 receives feedback regarding how to connect the parts and guidance as the guide 17 and guide follower 16 interact. It also reduces the risk of that the flex film 10 is turned in relation to the electronic connector 13 when it is moved towards the electronic connector 13. When connected, the pins 19 and the holes 17 interact to absorb forces as disclosed above.

The principles of the present invention have been described in the abovementioned by examples of embodiments or modes of operations. However, the invention should not be construed as being limited to the particular embodiments discussed above, which are illustrative rather than restrictive, and it should be appreciated that variations may be made in those embodiments by persons skilled in the art, without departing from the scope of the present invention as defined by the appended claims

1. Radio communication terminal comprising a flex film and a electrical connector, wherein
the flex film comprises at least one connector portion,
the connector portion is adapted to be electronically connected to the electrical connector,
the electrical connector comprises a guide,
the connector portion of the flex film comprises a guide follower, and
the guide and the guide follower are adapted to interact to connect the flex film to the electrical connector.

2. Radio communication terminal according to claim 1, wherein the guide and the guide follower are adapted to interact to absorb forces exerted on the flex film and the electrical connector.

3. Radio communication terminal according to claim 1, wherein the guide and the guide follower are adapted to interact to only enable a correct connection of the flex film to the electrical connector.

4. Radio communication terminal according to claim 1, wherein the guide comprises a pin.

5. Radio communication terminal according to claim 4, wherein the guide follower comprises a through hole in the connector portion of the flex film that is adapted to be mounted on the pin.

6. Radio communication terminal according to claim 1, wherein the guide comprises two pins.

7. Radio communication terminal according to claim 1, wherein the guide follower comprises two through holes.

8. Radio communication terminal according to claim 1, wherein the guide is positioned unsymmetrically in relation to the width of the electrical connector.

9. Radio communication terminal according to claim 1, wherein the cross sectional shape of the guide is unsymmetrical.

10. Radio communication terminal according to claim 4, wherein the cross sectional shape of the pin is unsymmetrical.

11. Radio communication terminal according to claim 1, wherein the shape of the guide follower corresponds to the shape of the guide.

12. Radio communication terminal according to 11 claim 4, wherein the cross sectional shape of the pin corresponds to the shape of the through hole.

13. Radio communication terminal according to claim 1, further comprising a printed circuit board and wherein the electrical connector is mounted on said printed circuit board.

14. Method for connecting a connector portion of a flex film comprising a guide follower to a electrical connector comprising a guide, comprising the steps of arranging the guide follower at the guide, moving the connection portion into a connected position in the electronic connector, whereby the movement is guided by the interaction of the guide follower and the guide.

15. Method according to claim 14, whereby the guide is a pin and the guide follower is a through hole, the pin is inserted into the hole and the pin and the hole interacts to guide the movement of the connector portion in relation to the electrical connector.

16. Method according to claim 15, wherein the pin and the through hole has a corresponding and unsymmetrical shape and that said pin only is arrangeable in said hole in one orientation.
